(19) United States
(12) Patent Application Publication
(10) Pub. No.: US 2016/0137223 A1
(43) Pub. Date: May 19, 2016

(54) STEERING SUPPORT STRUCTURE

(71) Applicant: TOYOTA JIDOSHA KABUSHIKI KAISHA, Toyota-shi (JP)

(72) Inventor: Hiroyuki KUROKAWA, Nisshin-shi (JP)

(73) Assignee: TOYOTA JIDOSHA KABUSHIKI KAISHA, Toyota-shi (JP)

(21) Appl. No.: 14/923,974

(22) Filed: Oct. 27, 2015

(30) Foreign Application Priority Data
Nov. 17, 2014 (JP) 2014-233031

(51) Int. Cl. B62D 7/16; B62D 27/02; B62D 25/04

(52) U.S. Cl. CPC B62D 7/16; B62D 25/04; B62D 27/02

(57) ABSTRACT

A steering support structure 10 is provided with a steering support member 20 and an assembly member 30. The steering support member 20 is formed in a shape with a single curve toward a vehicle body forward upper side and spans between a pair of front pillars 16. A vehicle width direction middle portion of the steering support member is supported at a cowl 50 via a steering column bracket 42 at which a steering mechanism 40 is mounted. The assembly member 30 is provided at the front pillars 16. A side bracket 22 is fixed to a vehicle width direction outer side end portion of the steering support member 20. A face of the assembly member 30 at which the side bracket 22 is mounted is a surface that is oriented to the vehicle rearward inner side in plan view.

### CROSS-REFERENCE TO RELATED APPLICATION

This application is based on and claims priority under 35 USC 119 from Japanese Patent Application No. 2014-233031 filed on Nov. 17, 2014, the disclosure of which is incorporated by reference herein.

### TECHNICAL FIELD

The present invention relates to a steering support structure.

### RELATED ART

A support structure for a steering mechanism has been known since heretofore (for example, see Japanese Patent Application Laid-Open (JP-A) No. 2002-225751) in which a steering support member formed in a shape with a single curve toward a vehicle body rearward lower side spans between front pillars and the steering mechanism is coupled to this steering support member.

However, there is still scope for improvement in a structure that improves support stiffness for a steering mechanism from a steering support member that spans between front pillars and supports the steering mechanism.

Furthermore, there is still scope for improvement in a structure that efficiently transmits a load inputted to a steering support member from a vehicle body forward side to front pillars.

### SUMMARY OF THE INVENTION

Accordingly, an object of the present invention is to provide a steering support structure that may improve support stiffness for a steering mechanism from a steering support member that spans between front pillars and that may efficiently transmit a load inputted to the steering support member from the vehicle body forward side to the front pillars.

### Solution to Problem

A steering support mechanism relating to a first aspect of the present invention includes: a steering support member that is formed in a shape having a single curve toward a vehicle body forward upper side and spans between a pair of front pillars, a vehicle width direction middle portion of the steering support member being supported at a cowl via a steering column bracket at which a steering mechanism is mounted; and an assembly member that is provided at each of the front pillars, a face of the assembly member at which a side bracket is mounted being oriented toward a vehicle rearward inner side in plan view, the side bracket being fixed to a vehicle width direction outer side end portion of the steering support member.

According to the steering support structure relating to the first aspect, the steering support member is formed in the shape having a single curve that is curved toward the vehicle body forward upper side, and the vehicle width direction middle portion thereof is supported at the cowl via the steering column bracket at which the steering mechanism is mounted. The face of the assembly member provided at each front pillar, to which face the side bracket fixed to the vehicle width direction outer side end portion of the steering support member is mounted, is oriented toward the vehicle rearward inner side in plan view.

Consequently, stresses applied to the steering support member by the steering mechanism are efficiently dispersed to the cowl and the front pillars, and the support stiffness of the steering support member for the steering mechanism is improved. In addition, a load inputted to the steering support member via the cowl from the vehicle body forward side is efficiently transmitted through the assembly members to the front pillars.

In a steering support mechanism relating to a second aspect of the present invention, in the steering support mechanism relating to the first aspect, the assembly member is formed in a block shape that extends to a vehicle rearward outer side.

According to the steering support structure relating to the second aspect, each assembly member is formed in the block shape that extends to the vehicle rearward outer side. Therefore, the support stiffness of the steering support member for the steering mechanism is effectively improved, in addition to which loads are more efficiently transmitted from the steering support member to the front pillars.

In a steering support mechanism relating to a third aspect of the present invention, in the steering support mechanism relating to the first aspect or the second aspect, the side bracket is fixed by fastening by a bolt to the front pillar via the assembly member.

According to the steering support structure relating to the third aspect, the side bracket is fixed by fastening by bolts to each of the front pillars with the assembly member interposed. Therefore, support stiffness of the steering support member for the steering mechanism is even further improved.

In a steering support mechanism relating to a fourth aspect of the present invention, in the steering support mechanism relating to the third aspect, a long hole portion that is long in the vehicle body front-rear direction is formed in the side bracket for insertion of the bolt.

According to the steering support structure relating to the fourth aspect, the long hole portion that is long in the vehicle body front-rear direction is formed in the side bracket for the insertion of the bolt. Therefore, assembly of the steering support member to the assembly member is easy.

In a steering support mechanism relating to a fifth aspect of the present invention, in the steering support mechanism relating to the fourth aspect, a plurality of long hole portions are formed in the vehicle body front-direction.

According to the steering support structure relating to the fifth aspect, a plural number of the long hole portion are formed in the vehicle body front-rear direction. Therefore, the steering support member is more securely assembled to the assembly member.

### ADVANTAGEOUS EFFECTS OF INVENTION

According to the steering support structure relating to the first aspect, the support stiffness for the steering mechanism from the steering support member spanning between the front pillars may be improved, in addition to which a load inputted to the steering support member from the vehicle body forward side may be efficiently transmitted to the front pillars.

According to the steering support structure relating to the second aspect, the support stiffness of the steering support member for the steering mechanism may be effectively improved, in addition to which loads may be more efficiently transmitted from the steering support member to the front pillars.

According to the steering support structure relating to the third aspect, the support stiffness of the steering support member for the steering mechanism may be even further improved.

According to the steering support structure relating to the fourth aspect, the steering support member may be easily assembled to the assembly member.

According to the steering support structure relating to the fifth aspect, the steering support member may be more securely assembled to the assembly member.

### BRIEF DESCRIPTION OF DRAWINGS

FIG. 1 is a perspective view showing a steering support structure in accordance with a present exemplary embodiment.

FIG. 2 is a plan view showing the steering support structure in accordance with the present exemplary embodiment.

FIG. 3 is a rear view showing the steering support structure in accordance with the present exemplary embodiment.

FIG. 4 is a plan view showing structures of a vehicle width direction outer side end portion of the steering support structure in accordance with the present exemplary embodiment.

FIG. 5 is a sectional view showing structures of a vehicle width direction middle portion of the steering support structure in accordance with the present exemplary embodiment.

FIG. 6A to FIG. 6C are schematic diagrams for describing a canceling moment of a steering support member of the steering support structure in accordance with the present exemplary embodiment.

### DESCRIPTION OF EMBODIMENTS

Herebelow, an exemplary embodiment relating to the present invention is described in detail in accordance with the drawings. For convenience of description, the arrow UP that is shown where appropriate in the drawings indicates a vehicle body upward direction, the arrow FR indicates a vehicle body forward direction, and the arrow RH indicates a vehicle body rightward direction. In the following descriptions, where the directions front, rear, up, down, left and right are recited without being particularly specified, the same represent the front and rear in the vehicle body front-rear direction, up and down in the vehicle body up-down direction, and left and right in the vehicle body left-right direction (the vehicle width direction).

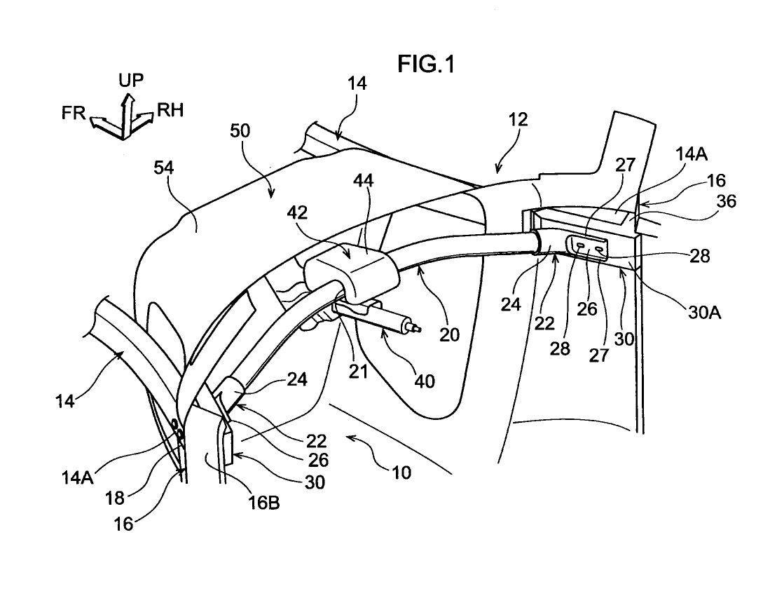

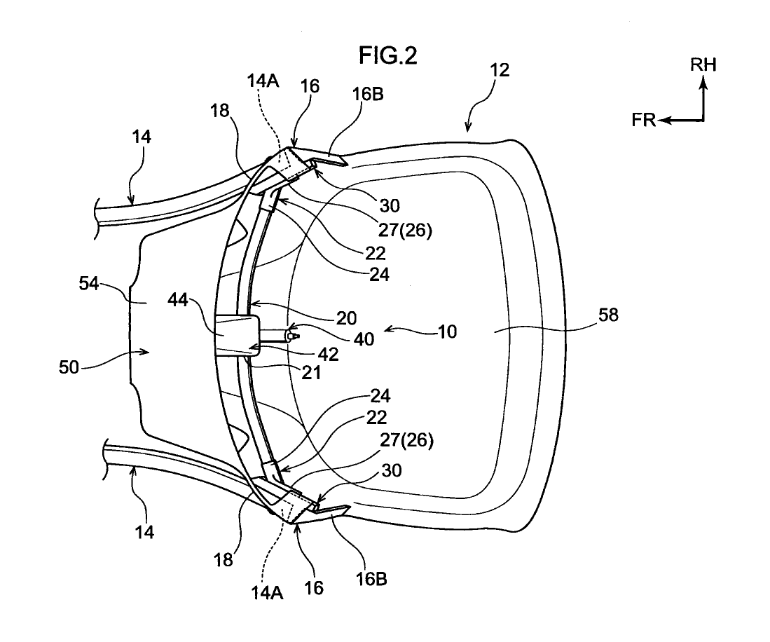

As shown in FIG. 1 and FIG. 2, a pair of left and right upper members 14 are provided at a front portion side of a vehicle body 12. Each upper member 14 extends in the vehicle body front-rear direction. The upper member 14 is formed with a rectangular closed cross section by extrusion molding of a lightweight metallic material such as aluminium or the like, with a constant cross-section. The upper member 14 is a vehicle body framework member with high strength and stiffness.

An aperture portion 18 is formed in each of a pair of left and right front pillars 16 that extend in the vehicle body up-down direction, at the side of each front pillar 16 at which a front portion 16A thereof is disposed. A rear end portion 14A of each upper member 14 is inserted into the respective aperture portion 18. Together with a plate portion 26 of a side bracket 22, which is described below, the rear end portion 14A of the upper member 14 is fixed by fastening to the front pillar 16 via an assembly member 30, which is described below.

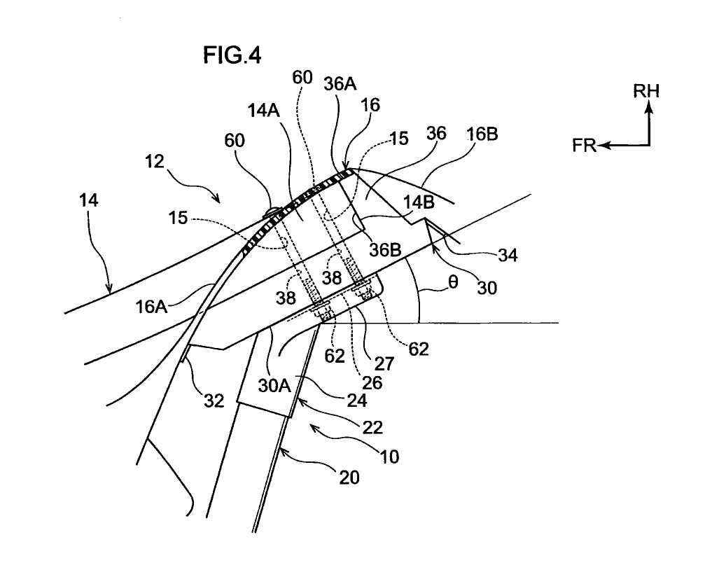

As shown in FIG. 4, two (plural) penetrating holes 15 for bolt insertion are formed in the rear end portion 14A of each upper member 14. The two penetrating holes 15 are arranged in the vehicle body front-rear direction. Each penetrating hole 15 penetrates through the rear end portion 14A in a direction orthogonal to the length direction of the upper member 14 in plan view.

As shown in FIG. 1 to FIG. 4, a steering support member 20 that structures a steering support structure 10 spans between the pair of left and right front pillars 16 at the vehicle width direction inner side of the upper members 14. The steering support member 20 is a pipe with a circular shape in cross section that is formed by extrusion molding of a lightweight metallic material such as aluminium or the like. The steering support member 20 is formed in a shape with a single curve that is curved toward the vehicle body forward upper side in the state in which the steering support member 20 is equipped to the vehicle body 12.

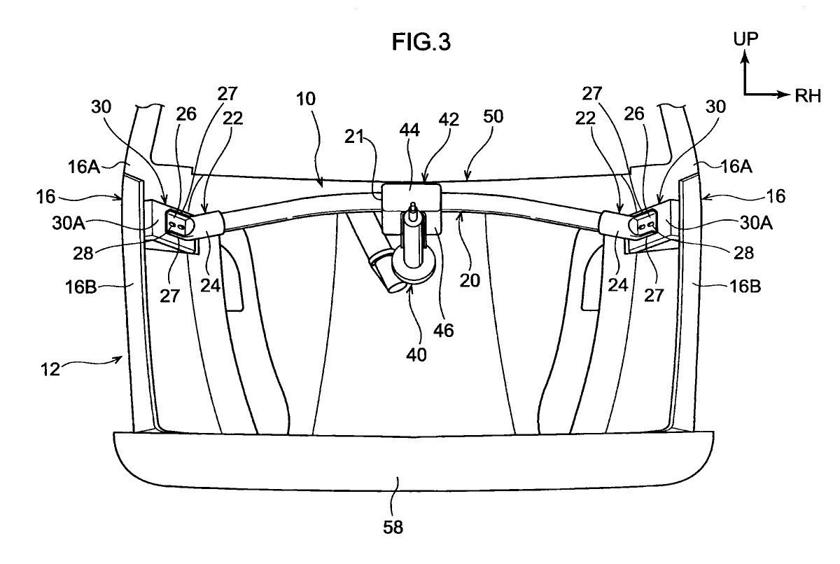

Thus, in the plan view shown in FIG. 2, the steering support member 20 is formed in a shape with a curve toward the vehicle body forward side and, in the rear view shown in FIG. 3, the steering support member 20 is formed in a shape with a curve toward the vehicle body upper side. The side brackets 22 are provided at vehicle width direction outer side end portions (each of two end portions) of the steering support member 20. The side brackets 22 are for mounting the steering support member 20 to the front pillars 16.

Each side bracket 22 includes a tubular portion 24, in the shape of a circular tube with a bottom, and the plate portion 26, in a flat plate shape. The plate portion 26 integrally extends toward the vehicle body rearward outer side from a vehicle width direction outer side end portion of the tubular portion 24. An inner diameter of the tubular portion 24 is equal to an outer diameter of the steering support member 20. The side brackets 22 are mounted to the two end portions of the steering support member 20 by the tubular portions 24 being tightly fitted onto the two end portions of the steering support member 20 and fixed by joining.

A vehicle body up-down direction length (width) of each plate portion 26 is a length substantially the same as the outer diameter of the tubular portion 24. The plate portion 26 extends toward the vehicle body rearward outer side. Flange portions 27 are integrally formed at the two upper and lower end portions of the plate portion 26. The flange portions 27 are folded back to the vehicle width direction inner side. Thus, a structure is formed that assures strength and stiffness of the plate portion 26. Two (plural) long hole portions 28 for bolt insertion are formed in the plate portion 26, arranged in the vehicle body front-rear direction (see FIG. 1 and FIG. 3). Length directions of the long hole portions 28 are along the vehicle body front-rear direction.

As shown in FIG. 1 to FIG. 4, each assembly member 30, with a block shape, is fixed by joining to the front pillar 16 between the rear end portion 14A of the upper member 14 and the side bracket 22 (the tubular portion 24 and plate portion 26).

The assembly member 30 is formed in a solid shape (but may have a hollow shape) of a lightweight metallic material such as aluminium or the like. The assembly member 30 functions as a reinforcing member for the front pillar 16. A vehicle body up-down direction length (width) of the assembly member 30 is a little larger than the vehicle body up-down direction length (width) of the plate portion 26 (see FIG. 1 and FIG. 3).

The assembly member 30 extends toward the vehicle body rearward outer side. A front end portion and rear end portion of the assembly member 30 are fixed by joining to the front pillar 16. To describe this in more detail, as shown in FIG. 4, the front pillar 16 is inflected in a substantial “V” shape such that the vehicle width direction inner side thereof is an opening side in plan view. That is, an inner face of the front pillar 16 at the side thereof at which a rear portion 16B is disposed is formed at an angle so as to face to the vehicle body forward inner side thereof, and an inner face of the front pillar 16 at the side thereof at which the front portion 16A is disposed is formed at an angle so as to face to the vehicle body rearward inner side thereof.

In plan view, the assembly member 30 is disposed substantially in parallel with the inner face of the front pillar 16 at the side thereof at which the front portion 16A is disposed. A flange portion 32 is formed at the front end portion of the assembly member 30 and is joined to the inner face of the front pillar 16 at the side at which the front portion 16A is disposed. Meanwhile, a flange portion 34 is formed at the rear end portion of the assembly member 30 and is joined to the inner face of the front pillar 16 at the side at which the rear portion 16B is disposed.

Thus, an inner face 30A of the assembly member 30 faces to the vehicle body rearward inner side. An angle of inclination θ of the inner face 30A with respect to the vehicle body front-rear direction is, for example, in the range 40°≦θ≦50° (in the present exemplary embodiment, the angle of inclination θ is set to 45°). The inner face 30A of the assembly member 30 abuts against (makes surface contact with) an outer face of the plate portion 26. Therefore, the outer face of the plate portion 26 is also angled at the angle of inclination θ with respect to the vehicle body front-rear direction.

A protrusion portion 36 with a block shape is integrally formed at the outer face of the assembly member 30 at the side at which the rear end portion thereof is disposed. The protrusion portion 36 protrudes to the vehicle width direction outer side with the same width as the assembly member 30. A distal end face 36A of the protrusion portion 36 is joined to the inner face of the front pillar 16 at the side at which the front portion 16A is disposed. Thus, the upper member 14 is inserted into the aperture portion 18 of the front pillar 16 along the outer face of the assembly member 30, and a rear end face 14B of the upper member 14 is positioned by abutting against a front face 36B of the protrusion portion 36.

Two (plural) penetrating holes 38 for bolt insertion are formed in the assembly member 30, arranged in the vehicle body front-rear direction, in a region at the vehicle body forward side relative to the protrusion portion 36. The penetrating holes 38 penetrate through the assembly member 30 in a direction orthogonal to the length direction of the assembly member 30 in plan view. The penetrating holes 38 communicate with the penetrating holes 15 of the upper member 14 and the long hole portions 28 of the plate portion 26.

Hence, the rear end portion 14A of the upper member 14 and the plate portion 26 are both fixed by fastening to the front pillar 16, with the assembly member 30 interposed, by bolts 60 being inserted into the penetrating holes 15 of the upper member 14, the penetrating holes 38 of the assembly member 30 and the long hole portions 28 of the plate portion 26 from the vehicle width direction outer side thereof and screwed into nuts 62.

When the steering support member 20 is to be mounted at the vehicle body 12, the steering support member 20 is moved from the vehicle body rearward side to the vehicle body forward side and the outer faces of the plate portions 26 of the side brackets 22 are put into surface contact with the inner faces 30A of the assembly members 30. Thus, the steering support member 20 is easily positioned and mounted to the assembly member 30 (the vehicle body 12).

As shown in FIG. 1 to FIG. 3, a steering mechanism 40, including a steering column which is not shown in the drawings, is mounted to a lower face side of a steering column bracket 42. The steering column bracket 42 is mounted to a vehicle width direction central portion (hereinafter referred to as “the curve central portion”) 21 of the steering support member 20. The curve central portion 21 of the steering support member 20 is supported at a cowl 50 via the steering column bracket 42. The cowl 50 is disposed at the vehicle body forward side relative to the steering support member 20.

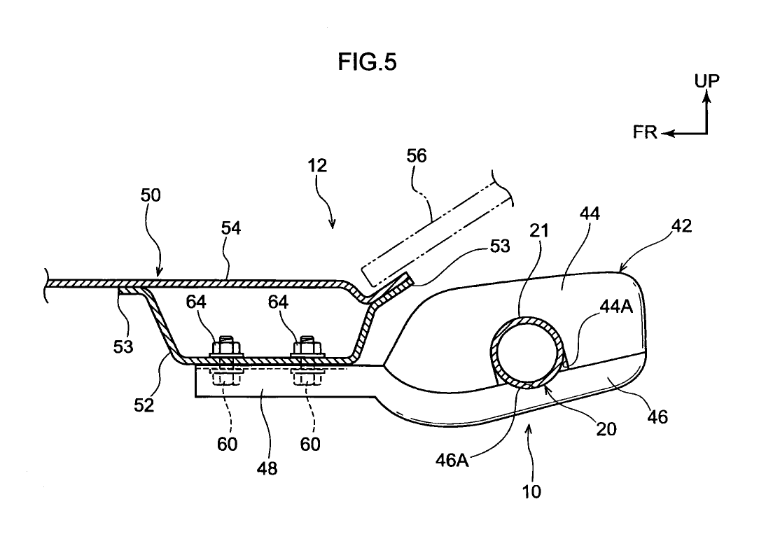

Describing this in more detail, as shown in FIG. 5, the steering column bracket 42 is a structure that is divided in two between upper and lower. The steering column bracket 42 includes an upper bracket 44 and a lower bracket 46. A notch portion 44A with a substantial “U” shape is formed in a lower edge portion of the upper bracket 44. A notch portion 46A with a circular arc shape is formed in an upper edge portion of the lower bracket 46.

The curve central portion 21 of the steering support member 20 is sandwiched in the vehicle body up-down direction between the notch portion 44A of the upper bracket 44 and the notch portion 46A of the lower bracket 46, and the notch portion 44A and notch portion 46A are joined by welding to the outer periphery face of the steering support member 20. In addition, the lower edge portion of the upper bracket 44 and the upper edge portion of the lower bracket 46 are joined by welding to one another. Thus, the steering column bracket 42 is fixed to the steering support member 20.

The cowl 50 includes a cowl lower 52, with a hat shape in cross section, and a cowl upper 54, with a flat plate shape. An opening side of the cowl lower 52 is at the vehicle body upper side thereof and the cowl lower 52 extends in the vehicle width direction. The cowl upper 54 closes off the vehicle body upper side of the cowl lower 52. That is, the cowl 50 is structured with a closed cross section shape by the cowl upper 54 being joined to front and rear flange portions 53 of the cowl lower 52. Therefore, strength and stiffness of the cowl 50 are assured.

The lower bracket 46 of the steering column bracket 42 includes an elongated portion 48 that extends to the vehicle body forward side. The elongated portion 48 is fixed by fastening to the lower face side of the cowl lower 52 by more of the bolts 60 with welded nuts 64. Accordingly, plural penetrating holes for bolt insertion (for example, two at front and rear) are formed in the cowl lower 52.

A windshield glass 56 that extends to the vehicle body upper rear side is provided at the vehicle body upper rear side of the cowl 50 (the cowl upper 54). Lower end portions of the front pillars 16 are fixed by joining to a floor panel 58 that structures the floor of a vehicle cabin.

Now, operations of the steering support structure 10 according to the present exemplary embodiment with the structure described above are described.

As shown in FIG. 1 to FIG. 3, the steering support member 20 that spans between the pair of left and right front pillars 16 is curved in a single curve toward the vehicle body forward upper side. That is, as shown in FIG. 2, the steering support member 20 curves toward the vehicle body forward side in plan view and, as shown in FIG. 3, the steering support member 20 curves toward the vehicle body upper side in rear view.

As shown in FIG. 4, the block-shaped assembly member 30 provided at the side of each front pillar 16 at which the front portion 16A is disposed and the plate portion 26 of the side bracket 22 fixed to each of the two end portions of the steering support member 20 are disposed at the inclination angle θ (for example, θ=45°) with respect to the vehicle body front-rear direction in plan view.

That is, the inner face 30A of the assembly member 30 is a surface that is oriented to the vehicle body rearward inner side in plan view. In the state in which the outer face of the plate portion 26 is in surface contact with the inner face 30A, the side bracket 22 of the steering support member 20 is mounted by bolt-fastening to the assembly member 30 along with the rear end portion 14A of the upper member 14.

As shown in FIG. 3 and FIG. 5, the steering column bracket 42 is fixed to the curve central portion 21 of the steering support member 20 that is curved toward the vehicle body upper side in rear view, and the elongated portion 48 of the lower bracket 46 of the steering column bracket 42 is mounted by bolt-fastening to the cowl lower 52 of the cowl 50.

Therefore, stresses that are applied to the steering support member 20 by the steering mechanism 40 may be efficiently dispersed to the cowl 50 and the front pillars 16. That is, the support stiffness of the steering support member 20 for the steering mechanism 40 may be greatly and effectively improved. As a result, vibrations produced in a steering wheel, which is not shown in the drawings, of the steering mechanism 40 may be reduced and handling stability performance of the vehicle may be improved.

Because the steering support member 20 is curved toward the vehicle body forward side in plan view, the steering support member 20 may generate a canceling moment in response to a collision load that is inputted from the vehicle body forward side. A moment that is produced when a load is inputted to a steering support member 100 with a linear shape and a moment that is produced when a load is inputted to the steering support member 20 with the curved shape are now described.

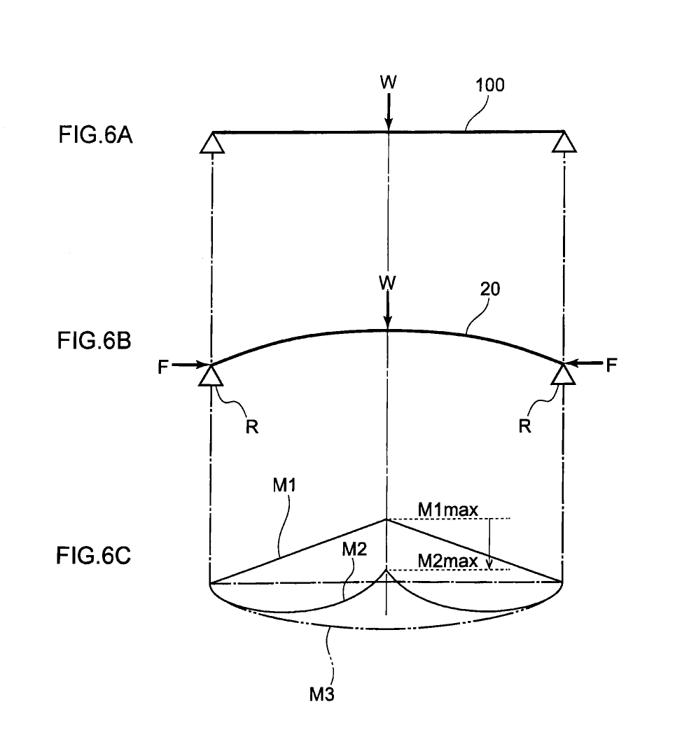

As shown in FIG. 6A and FIG. 6C, when a concentrated load W is inputted to a vehicle width direction central portion of the steering support member 100 with the linear shape, a maximum of a moment M1 acts on the steering support member 100 at the point of action of the concentrated load W. As shown in FIG. 6B and FIG. 6C, when the concentrated load W is inputted to the curve central portion 21 of the steering support member 20 with the curved shape, a maximum of a moment M2 acts on the steering support member 20 at the point of action of the concentrated load W.

The maximum value M2 max of the moment M2 is smaller than the maximum value M1max of the moment Ml. This is because fulcrum reaction forces F toward the curve central portion 21 are produced from fulcrums R that support the two end portions of the steering support member 20. Consequently, a canceling moment M3 is produced.

Thus, the steering support member 20 that is curved toward the vehicle body forward side in plan view may produce a canceling moment in response to a collision load inputted from the vehicle body forward side. Therefore, strength and stiffness with respect to an inputted collision load may be improved. As a result, a collision load inputted to the steering support member 20 from the vehicle body forward side may be efficiently transmitted to the front pillars 16 and the upper members 14. This is described below.

At a time of a frontal collision of the vehicle, a collision load inputted to the cowl 50 from the vehicle body forward side, via a power unit (engine), suspension and the like which are not shown in the drawings, is transmitted from the cowl 50 to the curve central portion 21 of the steering support member 20. The collision load transmitted to the curve central portion 21 of the steering support member 20 moves the steering support member 20 so as to extend the steering support member 20 to the vehicle body width direction outer sides. Consequently, the collision load is efficiently dispersed and transmitted from the two end portions of the steering support member 20, that is, the side brackets 22, through the assembly members 30 to the front pillars 16 and the upper members 14.

In particular, because the plate portions 26 of the side brackets 22 and the block-shaped assembly members 30 (and the front portion 16A side of each front pillar 16) are disposed at the inclination angle θ (for example, θ=45°) with respect to the vehicle body front-rear direction in plan view, the collision load may be smoothly (more efficiently) transmitted from the steering support member 20 through the plate portions 26 of the side brackets 22 and the assembly members 30 to the front pillars 16 and the upper members 14.

The sectional modulus of each front pillar 16, including the assembly member 30, with respect to a load toward the vehicle width direction outer side is higher than in a structure in which the front pillars are not angled at the inclination angle θ. Therefore, strength and stiffness of the front pillars 16 are properly assured even when a collision load is transmitted thereto. Thus, collision safety performance of the vehicle may be improved even when the steering support member 20 is structured of a lightweight metallic material such as aluminium or the like.

A radius of curvature of the steering support member 20 is suitably specified with a view to improving handling stability performance and collision safety performance of the vehicle. According to the steering support structure 10 in accordance with the present exemplary embodiment, reinforcement of the steering support member 20 by increased plate thickness, reinforcements or the like (an increase in the number of components) is not required and the structure is simple. Therefore, the vehicle may be reduced in weight, and productivity of the vehicle may be improved.

As described above, the length directions of the long hole portions 28 formed in each plate portion 26 are along the vehicle body front-rear direction. Therefore, even if there is an inconsistency in dimensions between the steering support member 20 and the assembly member 30, the long hole portions 28 of the plate portion 26 may be put into communication with the penetrating holes 38 of the assembly member 30 and the penetrating holes 15 of the upper member 14 by the plate portion 26 of the side bracket 22 being slid from the vehicle rearward side toward the vehicle forward side relative to the assembly member 30.

That is, according to the steering support structure 10 in accordance with the present exemplary embodiment, the steering support members 20 may absorb dimensional inconsistencies between the steering support members 20 and the assembly members 30 and be easily positioned and assembled to the assembly members 30. Therefore, ease of assembly of the steering support member 20 to the assembly members 30 (and the vehicle body 12) may be improved. It is desirable if the long hole portions 28 are formed plurally in a row in the vehicle body front-rear direction, as a result of which the steering support member 20 may be more securely assembled to the assembly members 30.

Hereabove, the steering support structure 10 according to the present exemplary embodiment has been described on the basis of the attached drawings. However, the steering support structure 10 according to the present exemplary embodiment is not limited to the illustrated structures; suitable design modifications may be applied within a scope not departing from the spirit of the present invention. For example, it is sufficient if the location at which the steering column bracket 42 is joined by welding is at a vehicle width direction middle portion of the steering support member 20. The location may be a location that is offset a little from the curve central portion 21 in the vehicle width direction.

It is sufficient if the penetrating holes 15 formed in the rear end portion 14A of each upper member 14, the penetrating holes 38 formed in each assembly member 30 and the long hole portions 28 formed in the plate portion 26 of each side bracket 22 are plurally formed in rows in the vehicle body front-rear direction. The present invention is not limited to structures in which two each thereof are formed in rows in the vehicle body front-rear direction.

Furthermore, the inclination angle θ in plan view of the assembly members 30 and the like with respect to the vehicle body front-rear direction is not limited to the range 40°≦θ≦50°. It is sufficient for the inclination angle θ to be set such that a collision load may be smoothly transmitted from the steering support member 20 through the plate portions 26 of the side brackets 22 and the assembly members 30 to the front pillars 16 and the upper members 14. It is also sufficient if at least the inner face 30A of each assembly member 30 is disposed at the inclination angle θ.

What is claimed is:

1. A steering support structure comprising:
a steering support member that is formed in a shape having a single curve toward a vehicle body forward upper side and spans between a pair of front pillars, a vehicle width direction middle portion of the steering support member being supported at a cowl via a steering column bracket at which a steering mechanism is mounted; and
an assembly member that is provided at each of the front pillars, a face of the assembly member at which a side bracket is mounted being oriented toward a vehicle rearward inner side in plan view, the side bracket being fixed to a vehicle width direction outer side end portion of the steering support member.

2. The steering support structure according to claim 1, wherein the assembly member is formed in a block shape that extends to a vehicle rearward outer side.

3. The steering support structure according to claim 1, wherein the side bracket is fixed by fastening by a bolt to each of the front pillars via the assembly member.

4. The steering support structure according to claim 3, wherein a long hole portion that is long in a vehicle body front-rear direction is formed in the side bracket for insertion of the bolt.

5. The steering support structure according to claim 4, wherein a plurality of long hole portions are formed in the vehicle body front-rear direction.
